(19) United States
(12) Patent Application Publication
(10) Pub. No.: US 2009/0102444 A1
(43) Pub. Date: Apr. 23, 2009

(54) DC-DC CONVERTER

(75) Inventor: Tomomi NONAKA, Matsumoto-City (JP)

Correspondence Address: ROSSI, KIMMS & McDOWELL LLP., 20609 Gordon Park Square, Suite 150, Ashburn, VA, 20147, US

(73) Assignee: FUJI ELECTRIC DEVICE TECHNOLOGY CO., LTD., Tokyo (JP)

(21) Appl. No.: 12/253,631

(22) Filed: Oct. 17, 2008

(30) Foreign Application Priority Data
Oct. 17, 2007 (JP) 2007-269694

(51) Int. Cl. G05F 1/00

(52) U.S. Cl. 323/282

(57) ABSTRACT

A DC-DC converter, which controls the output voltage supplied to a load at a desired magnitude by performing on/off control of the input voltage using a switch, includes: an error amplifier for outputting the difference voltage between the output voltage and a preset reference voltage; and a plurality of phase compensation circuits for compensating the phase of the output voltage fed back to the error amplifier with different characteristics, whereby the DC-DC converter is configured such that changes in either the input voltage or in the load current flowing into the load are detected, and switching between the plurality of phase compensation circuits is performed. The frequency characteristic of each of the phase compensation circuits is determined for each of a plurality of demarcated fluctuation ranges of the input voltage or the load current.

### BACKGROUND OF THE INVENTION

The invention relates to a DC-DC converter which changes a load current supplied to a load circuit by performing on/off control of a DC input voltage using a switching device to control a DC output voltage at a desired magnitude, and in particular relates to a DC-DC converter suitable for use as a DC power supply apparatus for portable electronic equipment using a rechargeable battery as a driving power supply.

In portable telephones and other electronic equipment of the prior art, rechargeable lithium batteries and similar rechargeable batteries are installed as power sources. In general, the output voltage of a battery declines depending on circumstances of equipment usage, battery discharge, etc., and so a DC-DC converter is provided to convert direct current into direct current at an arbitrary voltage (DC-DC conversion) in order to convert the battery voltage into a constant voltage for output. However, even when using the same DC-DC converter, depending on the electronic equipment, the voltage input to the DC-DC converter is different depending on the lithium battery specifications (for example, whether a number of lithium battery cells are connected in series). On the other hand, in electronic equipment that operates on a battery, mode-switching is performed into a mode in which a charged battery is maintained for a long period of time, and current consumption is reduced in order to lengthen the operation time of the electronic equipment. To this end, not only does the voltage difference between the input voltage and the output voltage change according to the battery specifications of the applied electronic equipment and the circumstances of use of the electronic equipment, but the load current itself also changes according to the state of use of the equipment.

In the past, DC-DC converters have been used in various electrical and electronic equipment, and DC-DC converters have been proposed according to the purpose of use, such as step-up DC-DC converters and step-down DC-DC converters having feedback loops employing voltage mode control or current mode control, and similar.

FIG. 8 is a circuit diagram showing a step-down type DC-DC converter of the prior art. This DC-DC converter comprises, within a control IC 1, a reference voltage generator 11, internal power supply 12, an error amplifier 13, preferably comprising an operation amplifier, a sawtooth wave generator 14, a PWM comparator 15, and an output MOS driver 16. A switch Q1, comprising a MOS transistor, is turned on and off by digital signals from the output MOS driver 16. An input voltage Vcc, with an input range of for example 2.5 V to 10 V, is supplied to the switch Q1, and when the switch Q1 performs switching operation, an output voltage Vo (for example, 2 V) lower than the input voltage Vcc is supplied to the load Ro by means of a commutation diode (flywheel diode) D, inductor L, and output smooth capacitor Cout.

At this time, in order to stabilize the output voltage Vo supplied to the load Ro through switching operation, a feedback voltage Vfb, which is normally obtained by voltage-dividing using sensing resistors Ra, Rb or similar, is supplied as negative feedback to the control IC 1. In the control IC 1, the error between the feedback voltage Vfb and the reference voltage Vref is amplified by the error amplifier 13, and is compared with the sawtooth wave signal voltage Vtr from the sawtooth wave generator 14 by the PWM comparator 15, the result is converted into a PWM (Pulse Width Modulation) signal which controls the time ratio (duty), and the signal from the output MOS driver 16 performs on/off control of the switch Q1.

As a result, the error voltage Verr output from the error amplifier 13 is controlled so as to increase when the feedback voltage Vfb is smaller than the reference voltage Vref and, conversely, to decrease when Vfb is larger than Vref, and by controlling the duty ratio of the switch Q1, the output voltage Vo is controlled.

The characteristic of such a DC-DC converter with voltage-mode control is such that oscillation readily occurs due to second-order lag of the main circuit comprising the inductor L and output smoothing capacitor Cout, and so phase compensation is indispensable in order to effect stable operation of the negative-feedback circuit. A general explanation relating to phase compensation to prevent oscillation in error amplifiers is given in OS-CON Conductive Polymer-Aluminum Solid Electrolytic Capacitors, Organic Semiconductor-Aluminum Solid Electrolytic Capacitors, Technical Book Ver. 14 (online), October 2006, SANYO Electronic Device Company (search date Aug. 31, 2007), <URL: HYPERLINK “http://edc.sanyo.com/pdf/oscon/OS” http://edc.sanyo.com/pdf/oscon/OS_Jpdf>.

If the capacitance value of the output capacitor is increased, the DC-DC converter is easily stabilized, but cost becomes a problem. A method may also be used of providing a resistance circuit in series with the output capacitor to advance the phase, but this is not desirable due to the fact that the power conversion efficiency of the DC-DC converter is lowered. As indicated in the above-referenced document currently the most widespread phase compensation employs, as a phase lag compensation circuit for the error amplifier 13, the series circuit of a resistor R1 and capacitor C1 connected between an inverting input terminal to which the feedback voltage Vfb is input and an output terminal, and, as a phase lead compensation circuit, the series circuit of a resistor R2 and capacitor C2 connected in parallel with the sensing resistor Ra.

In Japanese Patent Laid-open No. H05-304771 (paragraphs [0009] to [0017], FIG. 1), a circuit is disclosed in which, in contrast with continuous mode in which current always flows in the choke coil, because in discontinuous modes in which current flows intermittently in the choke coil below a critical point the DC-DC converter transfer function changes, a configuration is employed in which a feedback phase compensation circuit is selectively switched according to changes in the transfer function to suppress phase rotation.

Further, in Japanese Patent Laid-open No. 2006-304552 (paragraphs [0017] to [0066], FIG. 1), a circuit is disclosed in which a voltage follower and gain-adjusting resistor are provided between a voltage-dividing resistor and the error amplifier, and the resistance value of the gain-adjusting resistor is adjusted so as to be inversely proportional to the output voltage of the switching regulator, to hold constant the gain of the error amplifier stage.

Because the phase characteristic of a DC-DC converter varies greatly with the input voltage Vcc, output voltage Vo, load current Io, and other parameters, each of the constants of the phase compensation circuit must be set optimally taking these conditions into consideration. Further, for some applications of the DC-DC converter, it is also necessary to secure adequate response characteristics upon startup, rapid changes in the input voltage Vcc and load current Io, changes in the output voltage Vo, and similar.

However, in a DC power supply device for portable electronic equipment in which a rechargeable lithium battery or similar is used, the fluctuation ranges of the input voltage Vcc and load current Io of the DC-DC converter are set extremely broadly, and there are cases in which a simple combination of sensing compensation and error amplification compensation alone is insufficient to obtain adequate stability and response characteristics.

### SUMMARY OF THE INVENTION

The invention was devised in light of the above-described problems, and provides a DC-DC converter with a broad usage range as a DC power supply device, and in particular one which is capable of optimal phase compensation with a simple configuration, even when there are changes in the input voltage and load current.

More specifically, in order to resolve the above problems, a DC-DC converter is provided, which controls the DC output voltage supplied to a load circuit at a desired magnitude by performing on/off control of the DC input voltage using a switching device, including an error detection device, which outputs the difference voltage between the DC output voltage and a preset reference voltage; a phase compensation device, including a plurality of phase compensation circuits which use different characteristics to perform compensation of the phase of the DC output voltage fed back to the error detection device; and a switching control device, which detects changes in either the DC input voltage or in the load current flowing into the load circuit, and switches between the plurality of phase compensation circuits constituting the phase compensation device; and is characterized in that each of frequency characteristics of the phase compensation circuits is determined for each of a plurality of demarcated fluctuation ranges of the DC input voltage or the load current flowing into the load circuit.

In this DC-DC converter, switching control is performed such that the phase compensation circuit is switched to one phase compensation circuit when the input voltage or load current falls below a reference value, and is switched to another phase compensation circuit when the value rises above the reference value.

Accordingly, by means of this invention, phase compensation circuit constants can easily be set, and moreover the output voltage can be set with stability over all regions even when the input voltage range and load current range are broad.

### BRIEF DESCRIPTION OF THE DRAWINGS

The invention will now be described with reference to certain preferred embodiments thereof and the accompanying drawings, wherein:

FIG. 1 is a circuit diagram showing a DC-DC converter in accordance to a first embodiment of the invention;

FIG. 2 is a graph showing the single-loop gain frequency characteristic (amplitude frequency characteristic) of the DC-DC converter shown in FIG. 1;

FIG. 3 is a circuit diagram showing the DC-DC converter according to a second embodiment of the invention;

FIG. 4 shows the (first) results to determine the single-loop frequency characteristic of a DC-DC converter;

FIG. 5 shows the (second) results to determine the single-loop frequency characteristic of a DC-DC converter;

FIG. 6 shows the (third) results to determine the single-loop frequency characteristic of a DC-DC converter;

FIG. 7 shows the (fourth) results to determine the single-loop frequency characteristic of a DC-DC converter; and

FIG. 8 is a circuit diagram showing a step-down DC-DC converter of the prior art.

### DESCRIPTION OF THE PREFERRED EMBODIMENTS

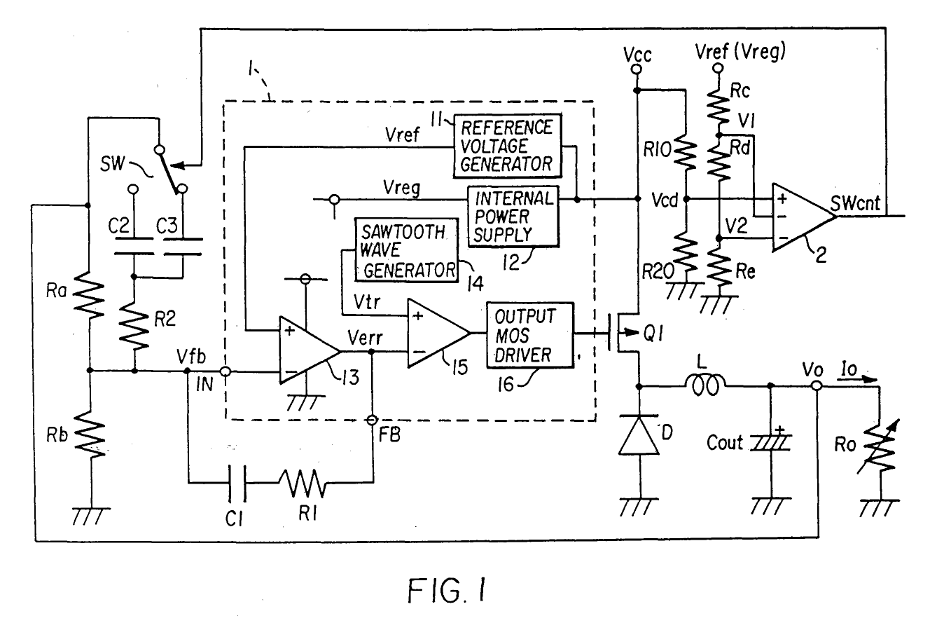

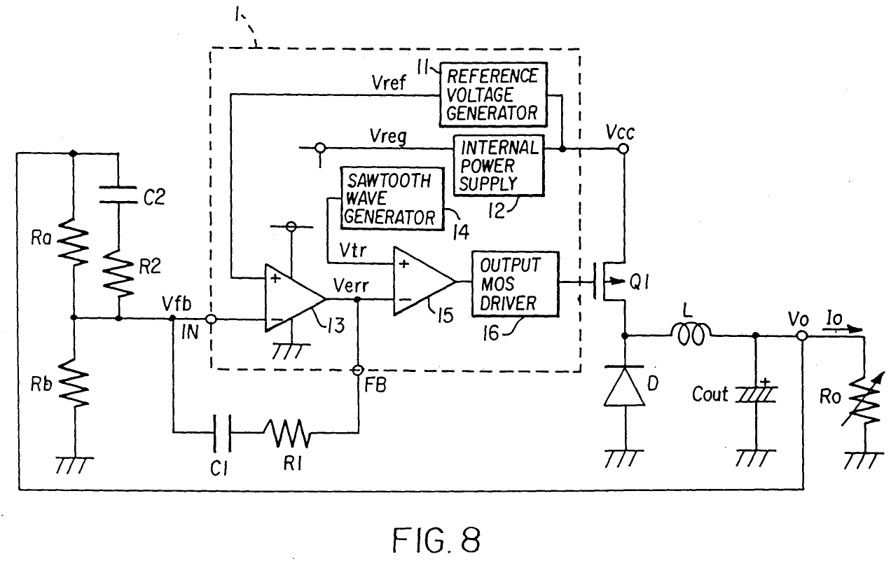

Below, preferred embodiments of the invention are explained referring to the drawings. FIG. 1 is a circuit diagram showing the DC-DC converter according to a first embodiment. Here, circuit elements corresponding to those of the circuit of the prior art in FIG. 8 are assigned the same symbols, and explanations thereof are omitted.

In this aspect, compared with the DC-DC converter of FIG. 8, a comparator 2 which outputs a switching control signal SWcnt, series resistors Rc, Rd, Re which set the reference voltages V1, V2 of this comparator 2, series resistors R10, R20 to voltage-divide the input voltage Vcc and generate a voltage signal Vcd which is supplied to the non-inverting input terminal of the comparator 2, a switch SW, and a capacitor C3 which is selected by the switch SW, are added. The comparator 2, series resistors Rc, Rd, Re, series resistors R10, R20, and switch SW forming switching control device. One end of the series resistors Rc, Rd, Re is connected to the constant voltage Vref or Vreg, and the other end is grounded. The potential V1 at the connection point of resistors Rc and Rd and the potential V2 at the connection point of resistors Rd and Re are input to the two inverting input terminals of the comparator 2 as reference voltages. The comparator 2 uses the two reference voltages V1 and V2 to operate as a hysteresis comparator. That is, the comparator 2 has a hysteresis characteristic such that, when the switching control signal SWcnt changes from H (high) to L (low), V2 becomes the reference voltage, and when the signal changes from L to H, V1 becomes the reference voltage. When the comparator 2 need not operate as a hysteresis comparator, the resistor Re may be omitted, so that only the reference voltage V1 is input to the comparator 2. The switch SW is controlled by switching control signals SWcnt of the comparator 2.

Here, the range of the input voltage Vcc for the DC-DC converter is 2.5 to 10 V, and moreover the load current Io flowing in the load Ro is assumed to vary in the range 0 to 1 A. A case is assumed in which, as explained above, in the prior art stable operation of the control IC 1 cannot be obtained over the entire range of the input voltage Vcc and load current Io.

Hence a case is here studied in which the input voltage Vcc initially changes in a low voltage range (2.5 to 6 V), and the resistance values and capacitance values (that is, capacitances C1 and C2 and resistances R1 and R2) for the optimal phase compensation circuit when the load current Io is from 0 to 1 A are determined. Then, for a high voltage range (4 to 10 V), upon similarly varying the load current Io between 0 and 1 A, with the capacitance C1 and the resistances R1 and R2 fixed, the capacitance value of capacitor C2 is studied. By this means, the value of a new capacitor C3 constituting the optimal phase compensation circuit can be determined.

The specific capacitance values and similar in a phase compensation circuit can be determined by analysis using well-known state averaging equations of the prior art, such as for example directly analyzing state averaging equations, or, when this is difficult, performing analyses using simulations (for information on state averaging methods, see for example Kousuke Harada et al, Fundamentals of Switching Converters (Corona Publishing Co., Ltd., 1992)). Or, experiments may be performed in advance to determine the resistance values of resistors, capacitance values of capacitors, and similar which are to be modified.

The resistance values of the series resistors Rc, Rd, Re are set so as to supply reference voltages V1 and V2 equal to the voltage values of voltage signals Vcd corresponding to the voltage values of the input voltage Vcc at which the high-voltage range and low-voltage range overlap (for example, 5.5 V and 4.5 V) (when there is no hysteresis, the values are set so as to supply V1, equal to the voltage signal Vcd corresponding to Vcc=5.0 V). A switching control signal SWcnt for the phase compensation circuit is supplied from the comparator 2 so as to switch the switch SW to the side of capacitor C2 when the input voltage Vcc falls to 4.5 V or lower, and so as to switch the switch SW to the side of capacitor C3 when the input voltage Vcc rises to 5.5 V or higher.

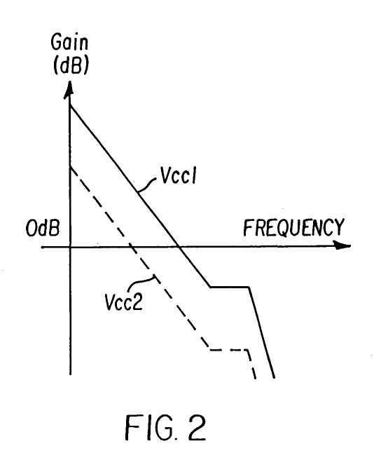

Fluctuations in the input voltage range will be explained with reference to FIG. 2. FIG. 2 is a graph showing the single-loop (open-loop) gain frequency characteristic (amplitude frequency characteristic) for the DC-DC converter shown in FIG. 1. However, here there is no switching between phase compensation circuits of the phase compensation device.

In FIG. 2, Vcc1, indicated by a solid line, and Vcc2, indicated by a broken line, are two input voltages to the DC-DC converter; a case is shown in which Vcc1>Vcc2. As shown in FIG. 2, the entire (single-loop) gain of the DC-DC converter for input voltage Vcc2 is low compared with that for the input voltage Vcc1. That is, if no measures are taken with respect to changes in input voltage, as the input voltage declines the band (cutoff frequency) of the DC-DC converter falls. Also, the single-loop phase characteristic (change in phase lag with frequency) of the DC-DC converter does not change with the input voltage, so that the phase margin also worsens. As a result, as the input voltage falls, the startup time during transient response of the DC-DC converter is lengthened, so that the response of the DC-DC converter is degraded, and in addition there is the problem that stability worsens.

Hence as explained above, by setting phase compensation circuit switching conditions in the DC-DC converter, so that the phase compensation circuit frequency characteristic is switched with an input voltage Vcc of 5 V as the borderline, then adequate response of the DC power supply apparatus can be secured over a broad range of fluctuation of the input voltage Vcc, and moreover operation can be made stable.

Further, the phase compensation circuit switched device is not limited to a capacitor C2 alone; the resistor R2 may be switched to different values, or, the phase lead compensation circuit on the side of the sensing resistors Ra, Rb may be left unmodified, while the magnitudes of the capacitor C1 and resistor R1 forming the phase lag compensation circuit for the error amplifier 13 may be modified. Or, a number of, or all of, the plurality of devices of the phase compensation circuit (capacitors C1 and C2, resistors R1 and R2) may be switched at once. In essence, the values of switched devices may be selected such that the DC-DC converter frequency characteristic is stable over the entire range of fluctuation of the input voltage Vcc, which varies greatly.

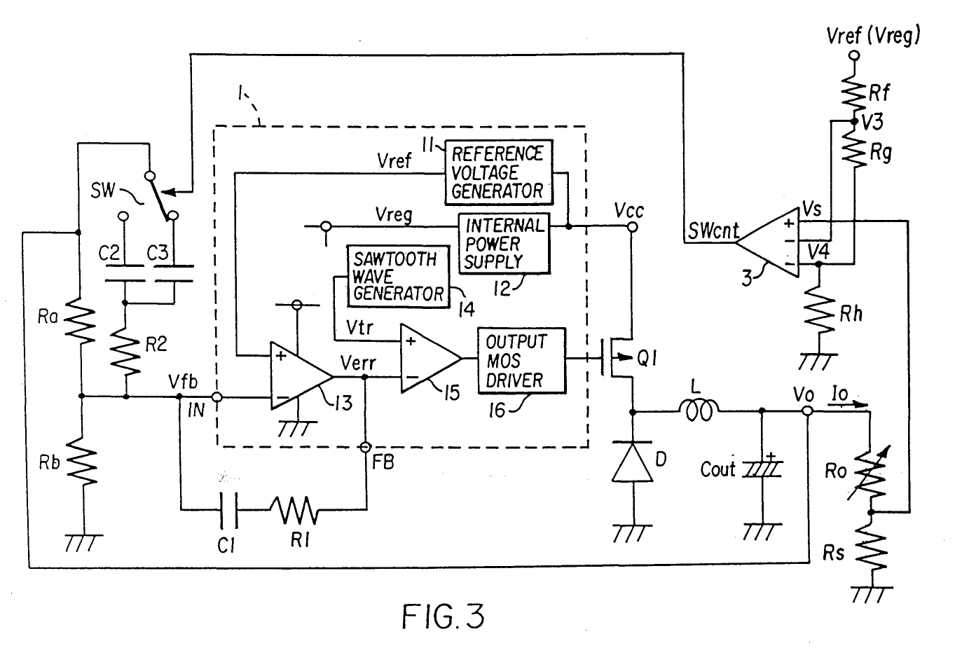

FIG. 3 is a circuit diagram showing the DC-DC converter according to a second embodiment of the invention. Here, a difference with the circuit of FIG. 1 is that a load current detection resistor Rs, one end of which is grounded, is added, connected in series to the load Ro, and the voltage thereon Vs is input to the non-inverting input terminal of the comparator 3. That is, whereas the switching control device of FIG. 1 is configured to perform switching according to the magnitude of the input voltage Vcc to the comparator 2, as the switching control device of FIG. 3, the comparator 3 performs switching according to the magnitude of the load current Io. The comparator 3, series resistors Rf, Rg, Rh, and reference voltages V3 and V4 are equivalent to the comparator 2, series resistors Rc, Rd, Re, and reference voltages V1 and V2 of FIG. 1, respectively, and perform the same respective functions. Also, explanations of cases in which hysteresis is and is not present are also similar, and so are omitted.

Here also, the range of the input voltage Vcc to the DC-DC converter is from 2.5 to 10 V, and moreover the load current Io flowing in the load Ro varies in the range 0 to 1 A. As explained above, a case has been assumed in which, in the prior art, stable operation of the control IC 1 cannot be obtained over the entire ranges of the input voltage Vcc and load current Io.

Here, a case is studied in which the load current Io is initially varied in a low-current range (0 to 0.6 A), and the resistance values and capacitance values (that is, the values of the capacitances C1, C2 and resistances R1, R2) of the optimal phase compensation circuit when the input voltage Vcc is varied between 2.5 and 10 V are determined. Then, in a high current range (0.4 to 1 A), the input voltage Vcc is similarly varied between 2.5 and 10 V, and with the capacitance C1 and the resistances R1 and R2 fixed, the capacitance value of the capacitor C2 is studied. By this means, the value of the new capacitor C4 used to form the optimal phase compensation circuit can be determined.

The resistance values of the series resistors Rc, Rd, Re are set so as to supply the reference voltages V3 and V4, equal to the voltage Vs from the load current detection resistor Rs equivalent to the current values at which the high-current range and the low-current range of the load current Io overlap (for example, 0.55 A and 0.45 A). Here, the comparator 3 supplies a phase compensation circuit switching control signal SWcnt such that, when the voltage Vs supplied to the non-inverting input terminal of the comparator 3 is equal to or less than the reference voltage V4, the switch SW is switched to the side of the capacitor C2, and when the voltage Vs is equal to or greater than the reference voltage V3, the switch SW is switched to the side of the capacitor C4.

Fluctuation of the output current range will now be explained. If the magnitude of the load current Io is replaced with the magnitude of the impedance of the load Ro, then if the impedance of the load Ro changes, the transfer function of the entire system of the DC-DC converter including the load Ro also changes, and of course the response changes. In qualitative terms, in the case of a heavy load with a large load current Io (that is, a load Ro with low impedance), phase compensation is adjusted so as to speed system response to enable supply of a large current. However, if this phase compensation circuit is left unmodified, then in the case of a light load with a small current (that is, a load Ro with high impedance), instability tends to occur. Hence it is necessary to modify the frequency characteristic of the phase compensation circuit according to the magnitude of the load current Io.

Hence as explained above, by setting the phase compensation circuit switching conditions in the DC-DC converter, if the phase compensation circuit frequency characteristic is switched with a load current Io of 0.5 A as the borderline, then stable operation of the DC power supply apparatus can be attained within a broad range of fluctuation of the load current Io. Here, similarly to the case of Aspect 1, the comparator 3 can be given a prescribed hysteresis.

Next, the gain of a step-down type DC-DC converter, as well as a method of adjustment of the phase margin in the phase lag frequency characteristic, are explained based on simulation results for the frequency characteristic using the above-described state averaging method.

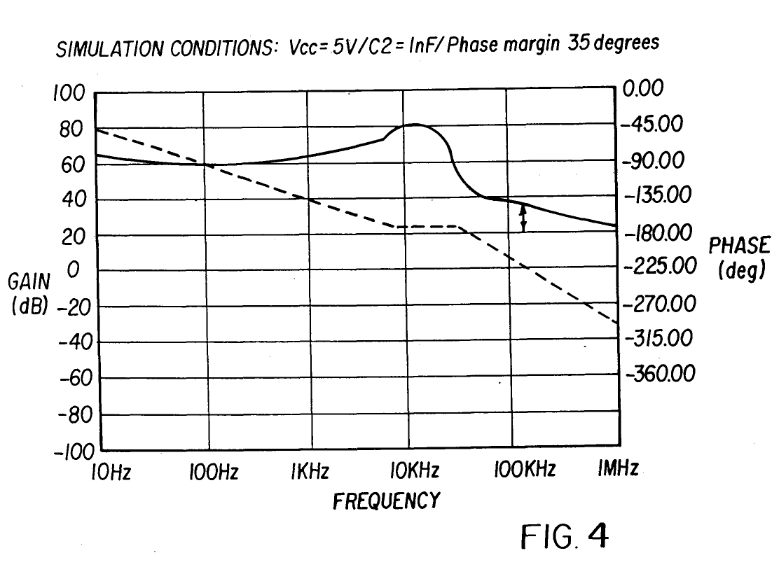

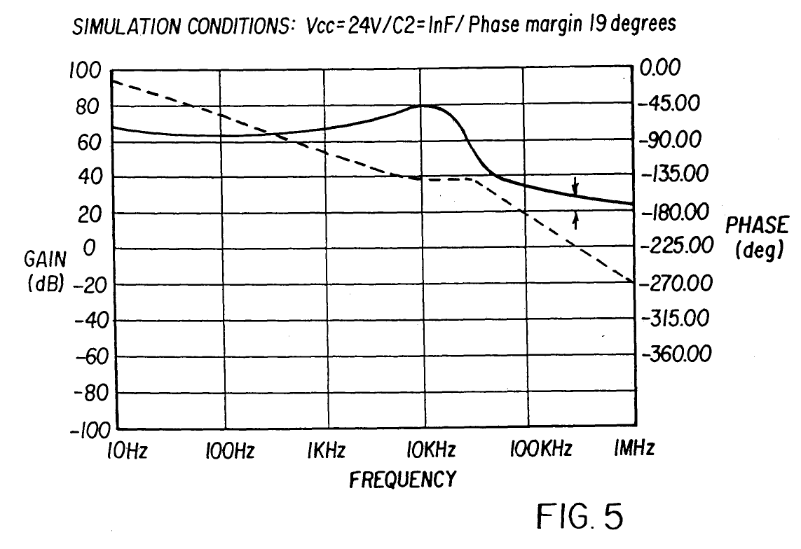

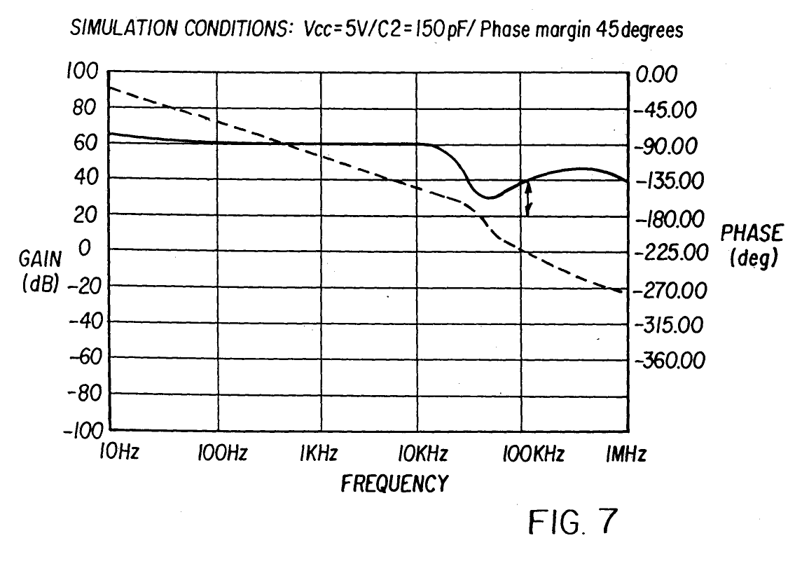

FIG. 4 to FIG. 7 show the results (first to fourth) of determination of the single-loop frequency characteristic of a DC-DC converter by simulations, all based on a state averaging method, indicating the phase margin when switching the capacitor of the phase lead compensation circuit between various values for an input voltage Vcc. In all of the figures, the horizontal axis indicates the frequency on a log scale, and the gain (dB) characteristic corresponding to the right-side vertical axis is indicated by a broken line, while the phase lag (deg) characteristic corresponding to the left-side vertical axis is indicated by a solid line. With the inductance L=10 μH, output smoothing capacitance Cout=4.7 μF, output voltage Vo=3 V, voltage-dividing resistances Ra=20 kΩ and Rb=10 kΩ, load resistance Ro=3Ω, and with the load current Io constant (=1 A), and under common conditions in which the phase lead compensation circuit resistance R1=6.2 kΩ and capacitance C1=470 pF and the phase lead compensation circuit resistance R2=1 kΩ, the respective frequency characteristics are calculated. In FIG. 4, the phase margin is shown when the input voltage Vcc is 5 V and the capacitance C2 is 1 nF. Under these conditions, the phase margin of the step-down DC-DC converter is 35 degrees. However, as shown in FIG. 5, when the input voltage Vcc rises to 24 V, if the capacitance C2 is left at 1 nF the phase margin shrinks to 19 degrees.

Here, the phase margin is the margin of the phase lag from a phase of 180 degrees when the amplification factor is 1 (gain of 0 dB); normally, a phase margin of approximately 30 to 40 degrees is desirable. Hence the step-down DC-DC converter is in a state in which oscillation occurs readily.

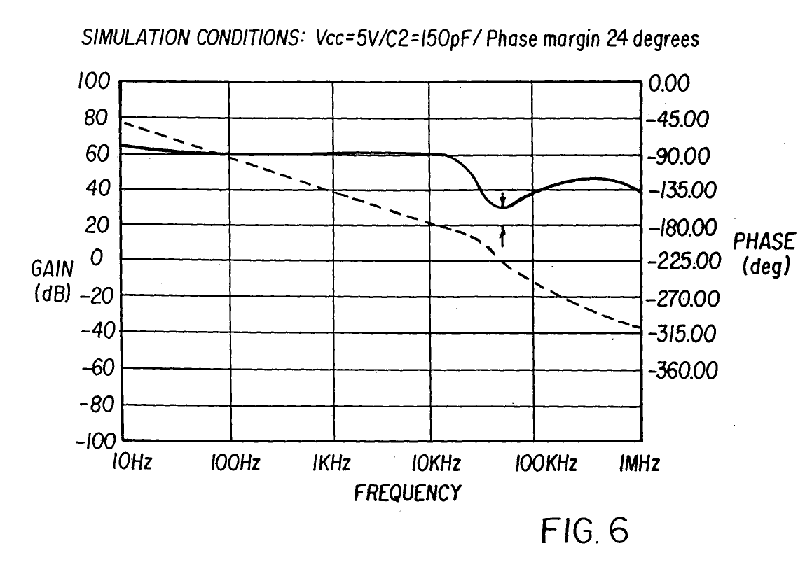

FIG. 5 and FIG. 6 show frequency characteristics when the capacitance C2 (=1 nF) of the phase lead compensation circuit is switched by the switch SW. Here, by switching to the capacitance C3 (=150 pF), when the input voltage Vcc=5 V in FIG. 5, the phase margin is 24 degrees, which is smaller than that in FIG. 4 with C2=1 nF, but when the input voltage Vcc rises to 24 V as in FIG. 6, the phase margin can be adjusted to 45 degrees.

That is, when the input voltage Vcc is 5 V the capacitance is switched to C2=1 nF, and when the input voltage Vcc is 24 V the capacitance is switched to C3=150 pF.

In both of the embodiments described above, examples of step-down DC-DCⁱ converters were explained; however, this invention can also be similarly applied to step-up type devices, or to polarity-inverting DC-DC converters, with prominent advantageous results obtained. Of course, in addition to voltage mode control, this invention can also be applied to DC-DC converters employing current mode control, in which inductor current feedback is employed.

The invention has been described with reference to certain preferred embodiments thereof. It will be understood, however, that modifications and variations are possible within the scope of the appended claims.

This application is based on, and claims priority to, Japanese Patent Application No: 2007-269694, filed on Oct. 17, 2007. The disclosure of the priority application, in its entirety, including the drawings, claims, and the specification thereof, is incorporated herein by reference.

What is claimed is:

1. A DC-DC converter, which controls a DC output voltage supplied to a load circuit at a desired magnitude by performing on/off control of a DC input voltage using switching device, comprising:
an error detection device, which outputs a difference voltage between the DC output voltage and a preset reference voltage;
a phase compensation device, comprising a plurality of phase compensation circuits which use different characteristics to perform compensation of the phase of the DC output voltage fed back to the error detection device; and
a switching control device, which detects changes in either the DC input voltage or in a load current flowing into the load circuit, and switches between the plurality of phase compensation circuits constituting the phase compensation device,
wherein each of frequency characteristics of the phase compensation circuits is determined for each of a plurality of demarcated fluctuation ranges of the DC input voltage or the load current flowing into the load circuit.

2. The DC-DC converter according to claim 1, wherein the switching control device modifies the frequency characteristic of the error detection device by switching the phase compensation device according to whether the DC input voltage is higher or lower than a preset voltage value.

3. The DC-DC converter according to claim 2, wherein switching of the phase compensation device is provided with a hysteresis characteristic.

4. The DC-DC converter according to claim 1, wherein the switching control device detects only changes in the DC input voltage.

5. The DC-DC converter according to claim 1, wherein the switching control device modifies the frequency characteristic of the error detection device by switching the phase compensation device according to whether the load current flowing into the load circuit is higher or lower than a reference current value.

6. The DC-DC converter according to claim 5, wherein switching of the phase compensation device is provided with a hysteresis characteristic.

7. The DC-DC converter according to claim 1, wherein the switching control device detects only changes in the load current flowing into the load circuit.

8. The DC-DC converter according to claim 1, wherein the switching control device simultaneously detects changes in the DC input voltage and changes in the load current.

9. The DC-DC converter according to claim 1, wherein the phase compensation device comprises a phase compensation circuit having at least two different frequency characteristics determined either by analysis using a state averaging equation or by an experimental device.

10. The DC-DC converter according to claim 9, wherein the phase compensation device is configured by a phase compensation circuit having two different frequency characteristics.

11. The DC-DC converter according to claim 10, wherein the DC output voltage is fed back to the error detection device via a voltage-dividing resistance circuit comprising the phase compensation circuit.

12. The DC-DC converter according to claim 10, wherein the error detection device has an error amplifier, and as the phase compensation circuit, a phase compensation resistor and a phase compensation capacitor are series-connected between an output terminal and an inverting input terminal of the error amplifier which outputs the difference voltage.

13. The DC-DC converter according to claim 1, wherein the switching device is provided so as to output the DC output voltage which is stepped-up with respect to the DC input voltage.

14. The DC-DC converter according to claim 1, wherein the switching device is provided so as to output the DC output voltage which is stepped-down with respect to the DC input voltage.

15. The DC-DC converter according to claim 1, wherein the switching device is provided so as to output the DC output voltage which is inverted in polarity with respect to the DC input voltage.
